(19) United States
(12) Patent Application Publication
(10) Pub. No.: US 2016/0334950 A1
(43) Pub. Date: Nov. 17, 2016

(54) GRAPHICAL NATURAL LANGUAGE BOOLEAN DEPENDENCY BUILDER AND METHODS OF USING THE SAME

(71) Applicants: Bradley Nelson, Lubbock, TX (US); Calvin Zant, Lubbock, TX (US)

(72) Inventors: Bradley Nelson, Lubbock, TX (US); Calvin Zant, Lubbock, TX (US)

(21) Appl. No.: 15/154,798

(22) Filed: May 13, 2016

Related U.S. Application Data
(60) Provisional application No. 62/160,815, filed on May 13, 2015.

(51) Int. Cl. G06F 3/0482; G06F 3/0484; G06F 3/0481; G06F 17/21; G06F 3/0486

(52) U.S. Cl. CPC G06F 3/0482; G06F 17/211; G06F 3/0486; G06F 3/04817; G06F 3/04842

(57) ABSTRACT

Disclosed herein are systems and methods of use directed to Boolean builders. More specifically, the disclosed invention relates to systems and methods of use directed to graphical Boolean dependency builder interfaces as part of business process flows. In embodiments, the disclosed systems are configured to provide an interface allowing a user of the system with little or no knowledge of programming to create complex Boolean expressions which are utilized in the system or software. The creation of the Boolean expressions are performed by the user dragging and dropping objects which are representative of data elements (operands) and operations (operators) as well as evaluation orders. In a further embodiment, the system is configured to allow the user of the system to utilize drop down menus and selection options to further create and modify the Boolean expressions. The created expressions may then be utilized as part of a business process flow to achieve the desired outputs or obtain the desired results.

### CROSS-REFERENCE TO RELATED APPLICATIONS

This application claims the benefit under Title 35 United States Code §119(e) of U.S. Provisional Patent Application Ser. No.: 62/160,815; Filed: May 13, 2015, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods of use directed to Boolean builders. More specifically, the present invention relates to systems and methods of use directed to graphical Boolean dependency builder interfaces as part of operational process flows.

### BACKGROUND OF THE INVENTION

Without limiting the scope of the disclosed systems and methods, the background is described in connection with novel Boolean builder interfaces.

In current system and software development environments, software programmers code functionality in systems to obtain certain behaviors and results. For example, only parts of the system, software, or operations should be performed or applied if certain conditions are met. An example of this would be only certain sales representatives or users are notified by email if a contract is finalized in a particular region. Requests to change functionality or logic go back to the programmers to implement the requested changes or functionality. This creates a constant request and wait environment requiring specialized expertise to implements the requests.

Boolean expressions or logic is often utilized to implement the functionality or logic. These expressions are utilized to represent the data and conditional processes in the systems and software. Boolean expressions utilize a combination of operators (expressions), operands (data elements), and parentheses to structure an order of expression evaluation to achieve desired results or output. To program these expressions requires not only programming knowledge, but also the database structure and naming conventions.

While all of the aforementioned approaches and designs may fulfill their unique purposes, none of them fulfill the needs for a practical, efficient, and effective means for providing a graphical Boolean builder interface that is user friendly to non programmers and able to be utilized in various business process flows within an organization.

The present invention therefore proposes a novel graphical Boolean builder interface that fulfills the needs of the shortcomings of the prior art.

### BRIEF SUMMARY OF THE INVENTION

The present invention, therefore, provides for systems and methods of use directed to graphical Boolean dependency builder interfaces.

In an embodiment, the system is comprised of computer readable medium and computer readable code configured to provide a user of the system an interface for creating graphically, Boolean dependencies.

In embodiments, the disclosed systems are configured to provide an interface allowing a user of the system with little or no knowledge of programming to create complex Boolean expressions which are utilized in the system or software. An initial development frame is provided with space to create the Boolean dependency expressions. The creation of the Boolean expressions are performed by the user dragging and dropping objects which are representative of data elements (operands) and operations (operators) as well as evaluation orders. In a further embodiment, the system is configured to allow the user of the system to utilize drop down menus and selection options to further create and modify the Boolean expressions. The created expressions may then be utilized as part of a business process flow to achieve the desired outputs or obtain the desired results.

In summary, the present invention discloses systems and methods directed to Boolean builders. More specifically, the present invention relates to systems and methods of use directed to graphical Boolean dependency builder interfaces as part of operational process flows.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system architecture diagram of the graphical Boolean dependency builder system in accordance with embodiments of the disclosure;

FIG. 2 is an initial presentation layer of the graphical Boolean dependency builder system in accordance with embodiments of the disclosure;

FIG. 3 is an initial data element selection of the graphical Boolean dependency builder system in accordance with embodiments of the disclosure;

FIG. 4 is an initial data element selection dependency of the graphical Boolean dependency builder system in accordance with embodiments of the disclosure;

FIG. 5 is a second data element selection dependency of the graphical Boolean dependency builder system in accordance with embodiments of the disclosure;

FIG. 6 is a dependency selection between the first data element and the second data element of the graphical Boolean dependency builder system in accordance with embodiments of the disclosure;

FIG. 7 is an initial data element selection dependency modification of the graphical Boolean dependency builder system in accordance with embodiments of the disclosure;

FIG. 8 illustrates the grouping configuration or function with dependency selections already made of the graphical Boolean dependency builder system in accordance with embodiments of the disclosure;

FIG. 9 illustrates a dependency modification of the grouping configuration or function with dependency selections already made of the graphical Boolean dependency builder system in accordance with embodiments of the disclosure;

FIG. 10 illustrates an initial grouping configuration or function of the graphical Boolean dependency builder system in accordance with embodiments of the disclosure;

FIG. 11 is a PO application utilizing dependencies built with the graphical Boolean dependency builder system in accordance with embodiments of the disclosure;

FIG. 12 is an event application utilizing dependencies built with the the graphical Boolean dependency builder system in accordance with embodiments of the disclosure;

FIG. 13 is a checklist application utilizing dependencies built with the the graphical Boolean dependency builder system in accordance with embodiments of the disclosure.

### DETAILED DESCRIPTION OF THE INVENTION

Disclosed herein is are systems and methods of use directed to graphical Boolean dependency builder interfaces. The numerous innovative teachings of the present invention will be described with particular reference to several embodiments (by way of example, and not of limitation).

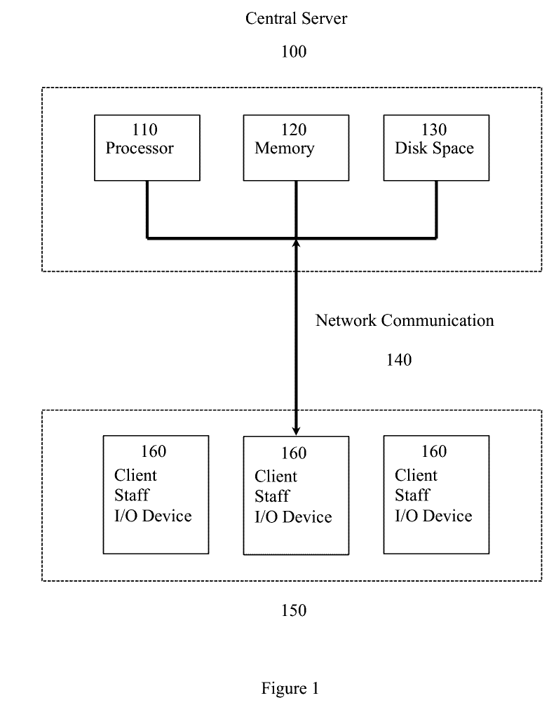

Reference is first made to FIG. 1, a system architecture diagram of the graphical Boolean dependency builder system in accordance with embodiments of the disclosure. This is a layout that may be used to implement one or more embodiments described herein. In an embodiment, the system is comprised of a central server 100, communication means 140, and one or more client input output device (I/O) 150.

The central server or computing device 100 is comprised of the essential components needed for software storage and execution such as but not limited to a processor 110, transitory computer readable storage medium 120, and non-transitory computer readable storage medium 130. The disk space, storage space, or also referred to as a persistent storage medium 130 is used for long-term storage of programs, data, an operating system, and other persistent information. In some embodiments, the disk space 130 may be higher latency than memory 120, but may characteristically have higher capacity. In other embodiments, a single hardware device may serve as both memory 120 and disk space 130. In embodiments of the disclosed system, the central server 100 is comprised of software for receiving, storing, and processing data and instructions received from the client I/O device 150. In other embodiments, the central server 100 may be one or a plurality of servers or computing devices configured to achieve the functions and operations described. For example, there may be a dedicated database server and a dedicated web server to function as the central server 100 component. In other embodiments the central server 100 and the client I/O device 150 are one component. In another embodiment, the central server 100 is the only component of the system and the user supplies his or her own client I/O device for interacting with the system.

The central server 100 and the client I/O device 150 are communicatively coupled 140. This may be accomplished through physical connections (such as cabling) or through wireless communications.

The client I/O device 150 may be any device that provides an interface to allow the user to interact with the central server or overall system 100. These I/O devices 150 may be a workstation, laptop, mobile device, computing pad, display watch, or any device allowing a user to interact with the system. In an embodiment, client software is installed on the I/O device 150 to provide a user of the system with a presentation layer or a graphical user interface (GUI) to interact with the central server or overall system 150.

In embodiments, as an example implementation and not a limitation, the system may be configured utilizing coding in T-SQL, C#, HTML, CSS, JavaScript, and JQuery languages. Additionally, portions of the .Net framework and ComponentArt Web.UI framework may also be implemented.

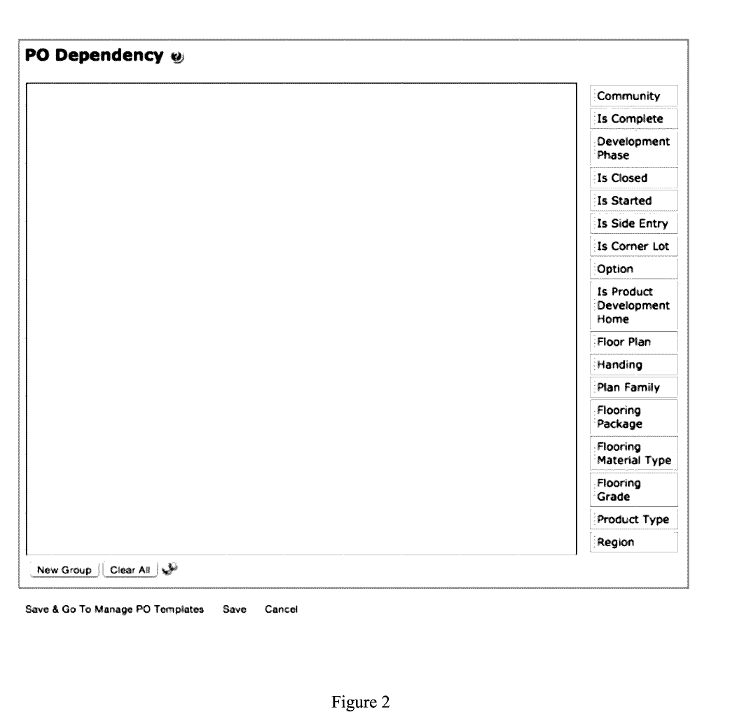

Reference is now made to FIG. 2, an initial presentation layer of the graphical Boolean dependency builder system in accordance with embodiments of the disclosure. In embodiments, the disclosed systems are configured to provide an interface allowing a user of the system with little or no knowledge of programming to create complex Boolean expressions which are utilized as part of the system or software. Illustrated here is an initial development frame provided with space or a portion to create the Boolean dependency expressions. The creation space is the blank space under the title “PO Dependency” and above the action icons or controls “new group” and “clear all”. The title “PO Dependency” reflects the relation or connection of the graphical Boolean dependency builder system with other systems and software. In an embodiment, the interface may be embedded within other systems, software, and software portions. This provides the system with context sensitivity in how it operates and presents. In this example, the graphical Boolean dependency builder will generate dependencies for PO creation and management. This may also be referred to as a PO context setup or configuration. The creation of the Boolean expressions are performed by the user dragging and dropping objects which are representative of data elements (operands) and operations (operators) as well as evaluation orders.

Illustrated on the right side or right portion of the interface or development framework are data elements provided to the user to work with. In this illustration for a PO dependency or PO context, we have the following data elements: community, is complete, development phase, is closed, is started, is side entry, is corner lot, option, is product development home, floor plan, handling, plan family, flooring package flooring material type, flooring grade, product type, and region. The system in an embodiment, is context sensitive in that the system automatically displays the relevant data elements depending on the context or dependency. For example, and not a limitation, if the system is being used in a construction context, construction data elements are presented for the user to work with. As another example, and not a limitation, if the system is being used in a sales context, sales data elements are presented for the user to work with. The system is configured to automatically present to the user based on context, the proper data elements for selection and filtering. No reconfiguration by a skilled programmer is necessary. In embodiments, to work with a data element, the user simply clicks on or drags the data element object into the creation space.

The “clear all” action icon clears the creation space. The “new group” action icon started a new group box.

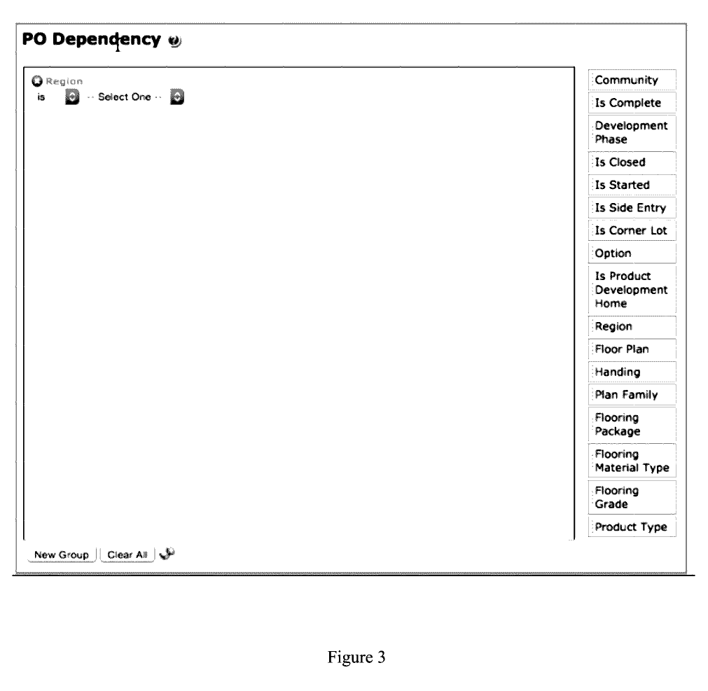

Reference is next made to FIG. 3, an initial data element selection of the graphical Boolean dependency builder system in accordance with embodiments of the disclosure. In this illustration, shown is the “region” data element dragged and dropped into the creation space. In further embodiments, the system is configured to allow the user of the system to utilize drop down menus and selection options to further create and modify the Boolean expressions. In embodiments, as illustrated here, the system automatically populates the selection options for specifying dependencies on that data element. The created expressions may then be utilized as part of a business process flow to achieve the desired outputs or obtain the desired results.

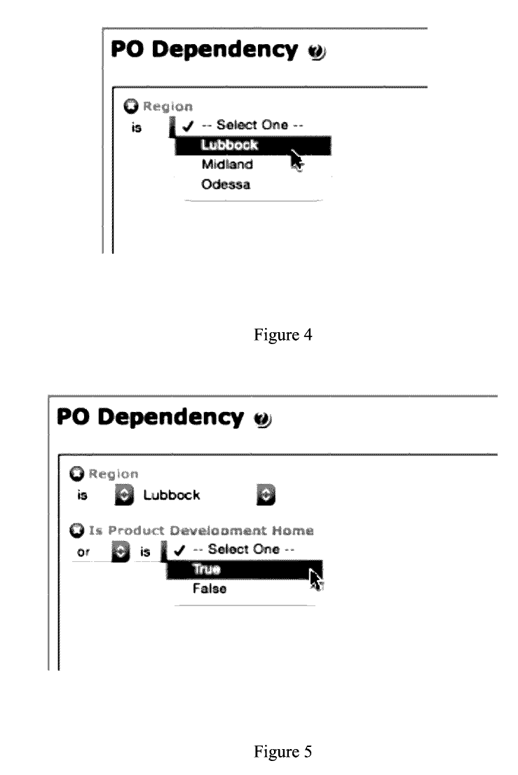

Reference is now made to FIG. 4, an initial data element selection dependency of the graphical Boolean dependency builder system in accordance with embodiments of the disclosure. Continuing with the PO Dependency example, the user is allowed to specify “is” or “is not” for the region selection. In addition, the user is provided the option to select the region: Lubbock, Midland, or Odessa.

Reference is next made to FIG. 5, a second data element selection dependency of the graphical Boolean dependency builder system in accordance with embodiments of the disclosure. Illustrated here is the continuation of the Boolean dependency expression being built with the system. A second data element “is product development home” has been selected or dragged and dropped into the creation space with the selection options automatically populated for specifying dependencies on that data element. The options of “is” or “is not” is provided as well as the option to specify “true” or “false”.

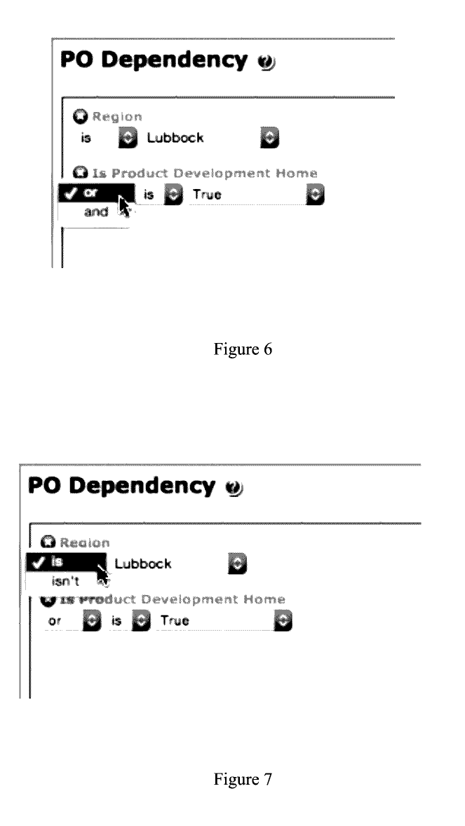

Reference is now made to FIG. 6, a dependency selection between the first data element and the second data element of the graphical Boolean dependency builder system in accordance with embodiments of the disclosure. Illustrated here is the system presentation of specifying the data element dependencies between each other for generating a Boolean expression. Here the option of “or” and “and” is presented to the user. Also seen in this illustration is the delete icon to the left of each data element in the creation space. This icon allows the user of the system to remove the data element form the Boolean expression.

Reference is next made to FIG. 7, an initial data element selection dependency modification of the graphical Boolean dependency builder system in accordance with embodiments of the disclosure. Illustrated here is the option to specify “is” or “is not” on the region data element.

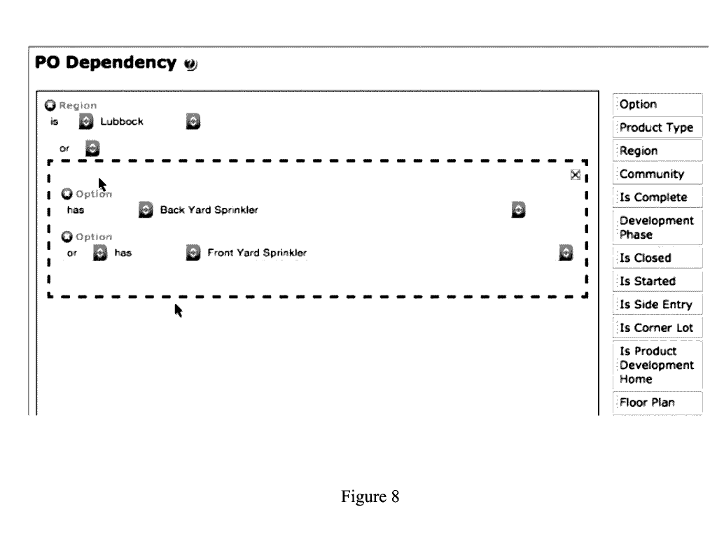

Reference is now made to FIG. 8, which illustrates the grouping configuration or function with dependency selections already made of the graphical Boolean dependency builder system in accordance with embodiments of the disclosure. Illustrated here is the selection of the “new group” action icon. A dotted group box is created in the creation space that allows the user of the system to drop data elements into the dotted group box. The dotted group box is configured by the system to treat the data elements in the dotted group box as being in parenthesis. Shown here are two “option” data elements in the dotted group box with one specifying “has backyard sprinkler” and the other specifying “has front yard sprinkler”.

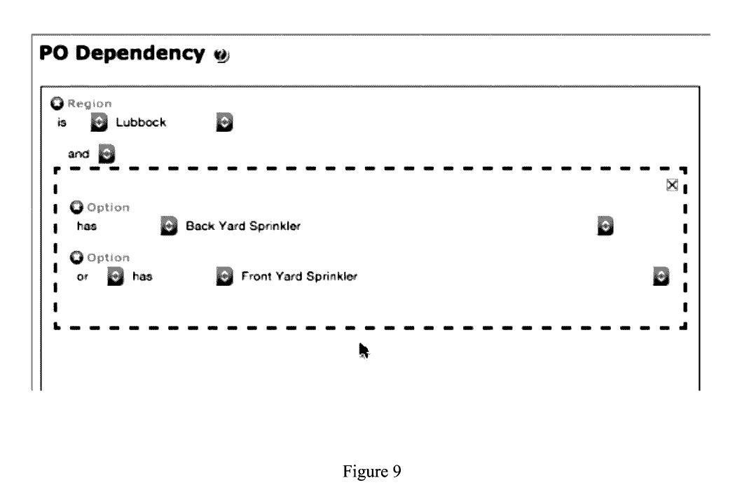

Reference is next made to FIG. 9, which illustrates a dependency modification of the grouping configuration or function with dependency selections already made of the graphical Boolean dependency builder system in accordance with embodiments of the disclosure. Illustrated here is the system presentation of specifying the data element and dotted group box dependencies between each other for generating a Boolean expression. Here the option of “or” and “and” is presented to the user. The previous figure had “or” selected and the user has changed the selection to “and”. The Boolean expression created by the user is as follows:

Region=Lubbock and (has backyard sprinkler or has front yard sprinkler)

In true programming form, the expression may look similar to the following:

Select*from po_orders where po_order.region =“Lubbock” and where (po_order.option=“BYS” or po_order.option=“FYS”);

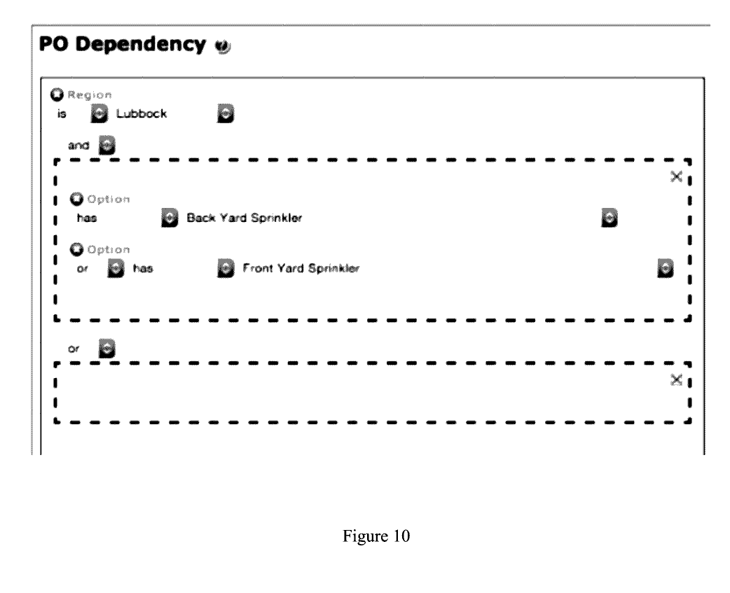

Reference is now made to FIG. 10, which illustrates an initial grouping configuration or function of the graphical Boolean dependency builder system in accordance with embodiments of the disclosure. Shown here is where the user of the system has selected to add another group to the Boolean dependency expression.

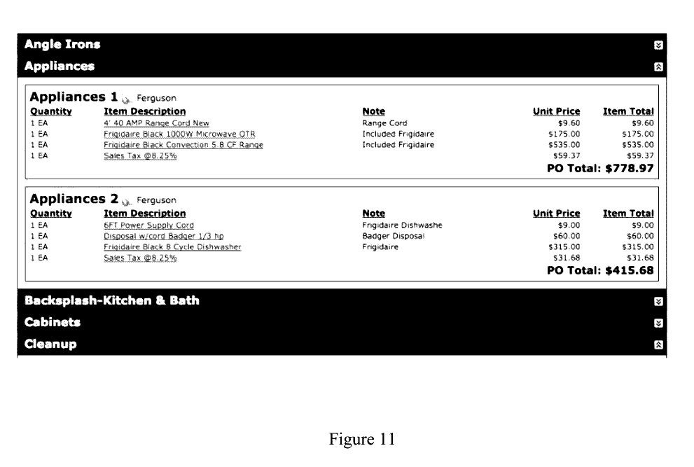

Reference is next made to FIG. 11, a PO application utilizing dependencies built with the graphical Boolean dependency builder system in accordance with embodiments of the disclosure. As mentioned previously, the graphical Boolean dependency builder allows individuals or users of the system to create complex Boolean expressions involving business logic and processes with a drag and drop interface. The graphical Boolean dependency builder system allows users to create complex behaviors in systems and software without any knowledge of code or software engineering. Illustrated here is an application or implementation of the graphical Boolean dependency builder PO expression. The dependencies may specify options to be added to POs or the selection of the POs based on the expression dependencies.

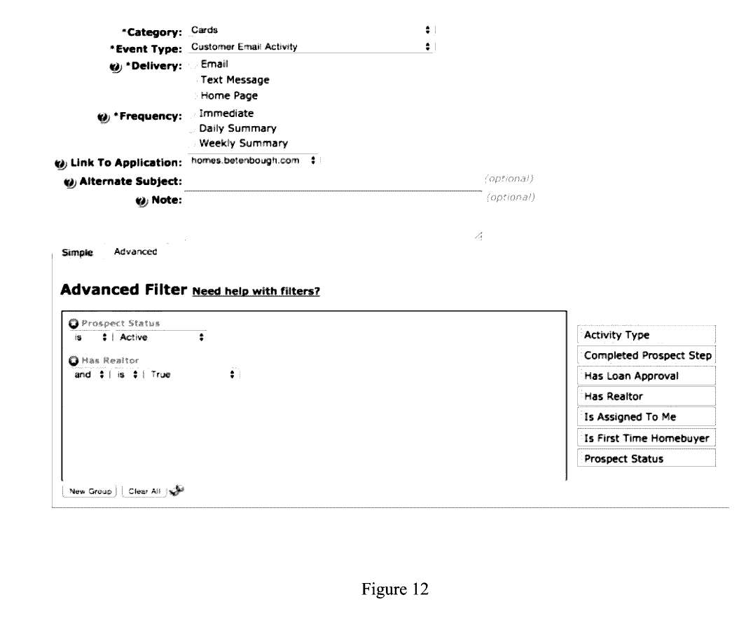

Reference is now made to FIG. 12, an event application utilizing dependencies built with the the graphical Boolean dependency builder system in accordance with embodiments of the disclosure. Another application of the graphical Boolean dependency builder is in the area of notifications or communications. Here the system or application allows the notification to be sent through various means. The graphical Boolean dependency builder has built an expression specifying the data element “prospect status” is active and the data element “has realtor” as being true. If this condition is met, the notification is sent.

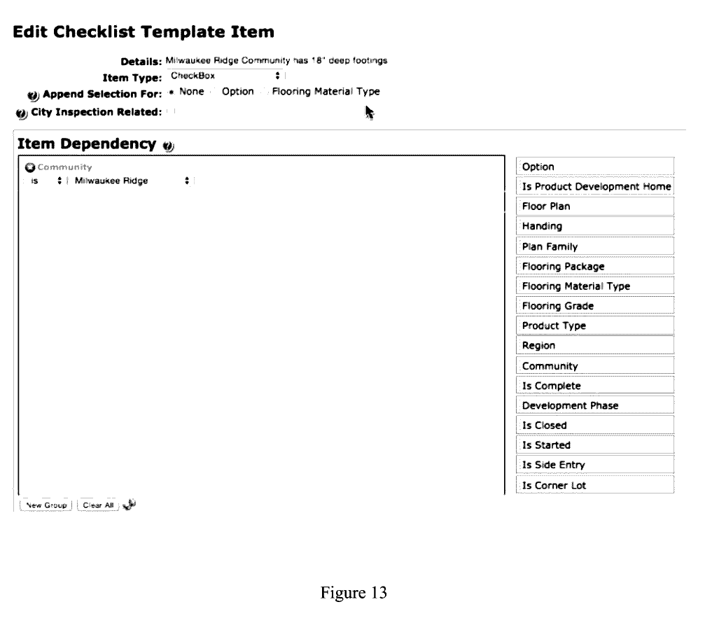

Reference is lastly made to FIG. 13, a checklist application utilizing dependencies built with the graphical Boolean dependency builder system in accordance with embodiments of the disclosure. Another application of the graphical Boolean dependency builder is in the area of checklists. Here the checklists can be generated under certain dependencies built with the graphical Boolean dependency builder. The graphical Boolean dependency builder has built an expression specifying the data element “community” is Milwaukee Ridge. As can be seen from the last few examples, the graphical Boolean dependency builder may be utilized in numerous business applications and as part of various workflows to achieve the desired output and results.

In brief, as described herein provides for systems and methods of use directed to graphical Boolean builders interfaces.

The disclosed systems and methods of use are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed systems or methods, except as may be outlined in the claims.

Alternative applications for this invention include using the systems and methods for various business process flows where filtering and Boolean logic needs to be implemented to drive the process or results. Consequently, any embodiments comprising a one piece or multi piece system having the structures and/or components as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods disclosed and claimed herein can be made and executed without undue experimentation in light of the present disclosure. While the systems and methods of this invention have been described in terms of preferred embodiments, it will be apparent to those skilled in the art that variations may be applied to the systems and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A graphical Boolean dependency builder system comprising:
a development frame having a creation space portion for building Boolean expressions and a right side portion comprising objects;
and wherein said system is configured to allow said objects to be dragged and dropped in said creation space to build Boolean expressions.

2. The graphical Boolean dependency builder system of claim 1, wherein said objects are operands.

3. The graphical Boolean dependency builder system of claim 1, wherein said objects are operands and operators.

3. The graphical Boolean dependency builder system of claim 1, wherein said objects are operands, operators, and evaluation orders.

4. The graphical Boolean dependency builder system of claim 1, further configured with a new group icon.

5. The graphical Boolean dependency builder system of claim 1, further configured with a clear all icon.

6. The graphical Boolean dependency builder system of claim 1, further configured with a new group icon and a clear all icon.

7. The graphical Boolean dependency builder system of claim 1, wherein said objects are operands, operators, and evaluation orders; and wherein the graphical Boolean dependency builder system is further configured with a new group icon and a clear all icon.

8. The graphical Boolean dependency builder system of claim 1, further configured for context sensitivity in the generation of said objects.

9. The graphical Boolean dependency builder system of claim 1, further configured for context sensitivity in the generation of a title for said development frame.

10. The graphical Boolean dependency builder system of claim 7, further configured for context sensitivity in the generation of said objects and a title for said development frame.

11. The graphical Boolean dependency builder system of claim 1, further configured when said objects in dropped in said creation space, drop down menus are presented to further create and modify Boolean expressions.

12. The graphical Boolean dependency builder system of claim 11, wherein said drop down menus presents an “is” and “is not” selection options.

13. The graphical Boolean dependency builder system of claim 11, wherein said drop down menus presents an “and” and “or not” selection options.

14. The graphical Boolean dependency builder system of claim 11, wherein said drop down menus presents an “is” and “is not” or an “and” and “or not” selection options.

15. The graphical Boolean dependency builder system of claim 7, further configured when said objects in dropped in said creation space, drop down menus are presented to further create and modify Boolean expressions.

16. A graphical Boolean dependency builder system comprising:
a development frame having a creation space portion for building Boolean expressions and a right side portion comprising objects;
and wherein said system is configured to allow said objects to be dragged and dropped in said creation space to build Boolean expressions;
wherein said objects are operands, operators, and evaluation orders;
and wherein said system is further configured with a new group icon and a clear all icon;
and wherein said system is further configured for context sensitivity in the generation of said objects and a title for said development frame;
and wherein said system is further configured for when said objects are dropped in said creation space, drop down menus are presented to further create and modify Boolean expressions;
and wherein said drop down menus presents an “is” and “is not” or an “and” and “or not” selection options.

17. The graphical Boolean dependency builder system of claim 16, further configured to have the output of said created Boolean expression to achieve the desired output or desired result for a business process flow.

18. The graphical Boolean dependency builder system of claim 17, wherein said business process flow is a purchase order.

19. The graphical Boolean dependency builder system of claim 17, wherein said business process flow is a notification or communication.

20. The graphical Boolean dependency builder system of claim 17, wherein said business process flow is a checklist.
